(19) United States
(12) Patent Application Publication
(10) Pub. No.: US 2008/0099279 A1
(43) Pub. Date: May 1, 2008

(54) Storage device for ladders

(76) Inventors: Donald Griswold, Tolland, CT (US); Hung Nguyen, Stoughton, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/590,040

(22) Filed: Oct. 31, 2006

(51) Int. Cl. E06C 5/32

(52) U.S. Cl. 182/129

(57) ABSTRACT

A storage device is particularly suitable for mounting to aluminum or fiberglass step ladders. A mounting assembly on one side of a planar member includes a track into which one leg of the ladder is fitted, and resilient clips that snap over the other leg of the ladder. A support member rests on a cross bar of the ladder. Storage bins are provided on the second side of the planar member. The storage bins may include covers that can be latched into the open or closed position. The storage device is able to remain in place on a step ladder even when the step ladder is folded up.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

Storage accessories mounted to ladders are known. Many of these storage accessories mount to step ladders, particularly to the top surface of the step ladder. Also, many of these accessories must be removed from the step ladder before the step ladder can be closed up or taken down.

### SUMMARY OF THE INVENTION

The present invention provides a storage device that mounts to legs of a ladder. The storage device is particularly suitable for mounting to aluminum or fiberglass step ladders having legs of relatively thin structural members. The storage device can remain in position mounted to the step ladder after the step ladder is closed.

In one embodiment, the storage device comprises a planar member. A mounting assembly is provided on a first side of the planar member and one or more storage bins are provided on the second side of the planar member.

The mounting assembly in one embodiment comprises a first leg attachment member comprising a track adjacent a first side edge for receiving a vertical leg of the ladder and a second leg attachment member comprising a resilient clip adjacent a second side edge for receiving another vertical leg of the ladder. A support member is provided adjacent the bottom edge for resting on a horizontal cross bar of the ladder.

The storage bin in one embodiment comprises a box having an open top and a cover hingedly mounted to the second side of the planar member to cover the open top of the box. A latching mechanism is provided for latching the cover in an open position and/or for latching the cover in a closed position.

### DESCRIPTION OF THE DRAWINGS

The invention will be more fully understood by reference to the following detailed description when considered in conjunction with the accompanying drawings, in which:

FIG. 1 is an isometric view of an embodiment of a storage device according to the present invention;

FIG. 2 is a front view of the storage device of FIG. 1 mounted on a step ladder;

FIG. 3 is a side view of the storage device of FIG. 1 mounted on a step ladder;

FIG. 4 is a rear view of a storage device illustrating an embodiment of a mounting assembly;

FIG. 5 is a top view of the storage device of FIG. 4;

FIG. 6 is a side view of the storage device of FIG. 4;

FIG. 7 is a top view of a mounting assembly clip for the storage device of FIG. 4;

FIG. 8 is a front view of a storage device illustrating an embodiment of a storage bin;

FIG. 9 is a side view of the storage device illustrating the storage bin of FIG. 8; and

FIG. 10 is an exploded view of the storage bin of FIG. 8.

### DETAILED DESCRIPTION OF THE INVENTION

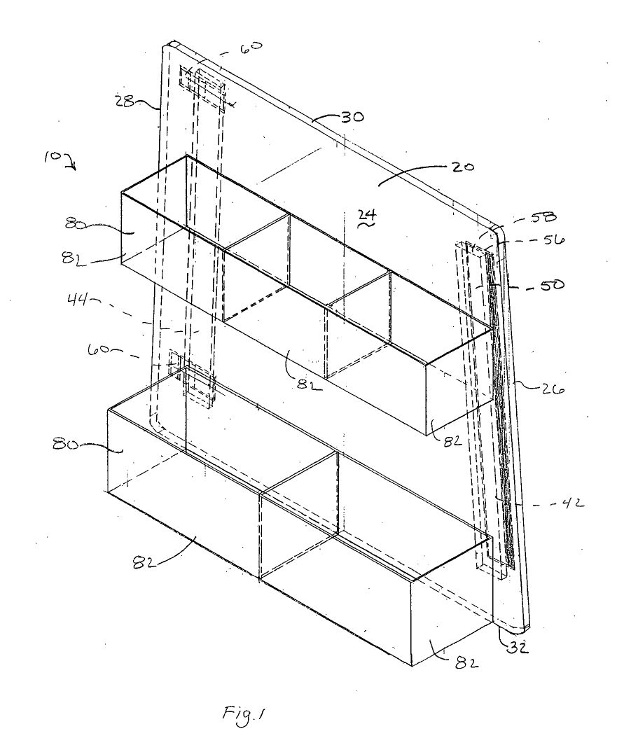

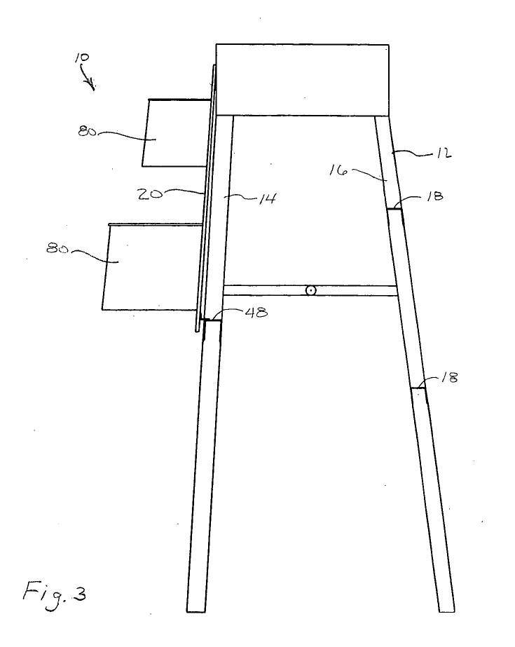

A ladder storage device 10 according to the present invention is illustrated in FIGS. 1-3. The storage device is particularly suitable for mounting to a step ladder 12 made of aluminum or fiberglass, which has legs formed of relatively thin channel- or angle-shaped structural members. The device mounts to the set of legs 14 opposite the legs 16 that support the steps 18 of the step ladder. The storage device is able to remain in place on a step ladder even when the step ladder is folded up.

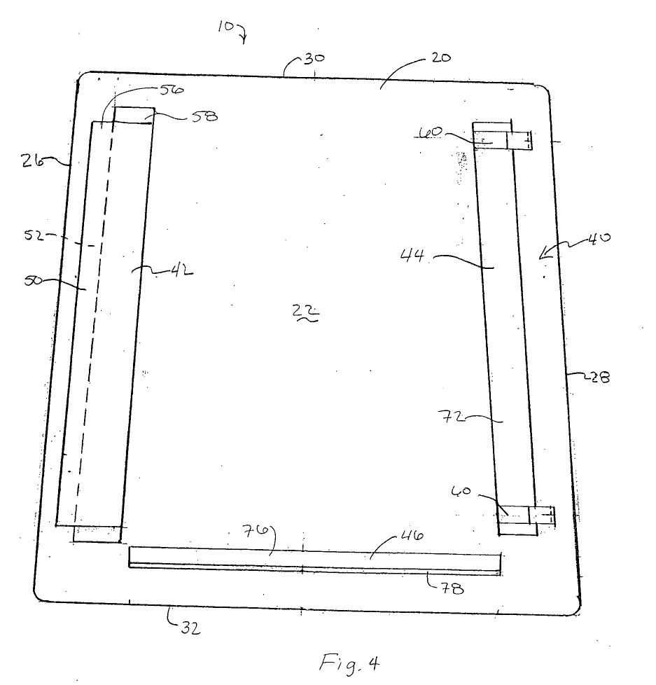

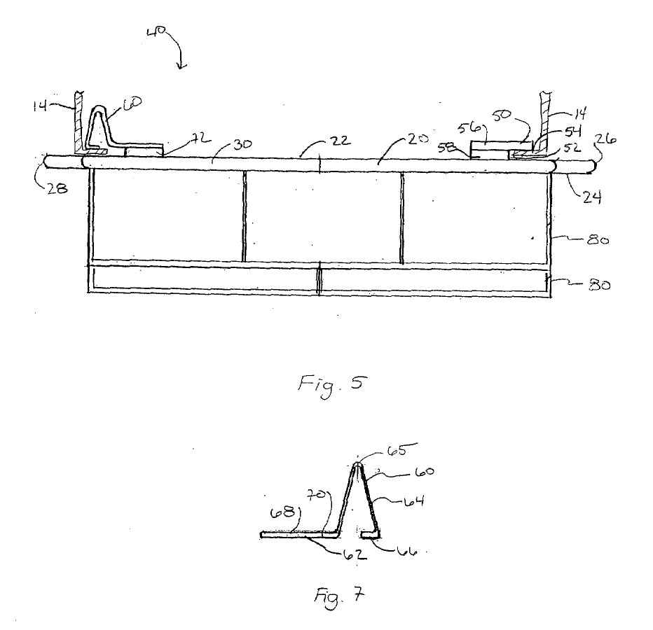

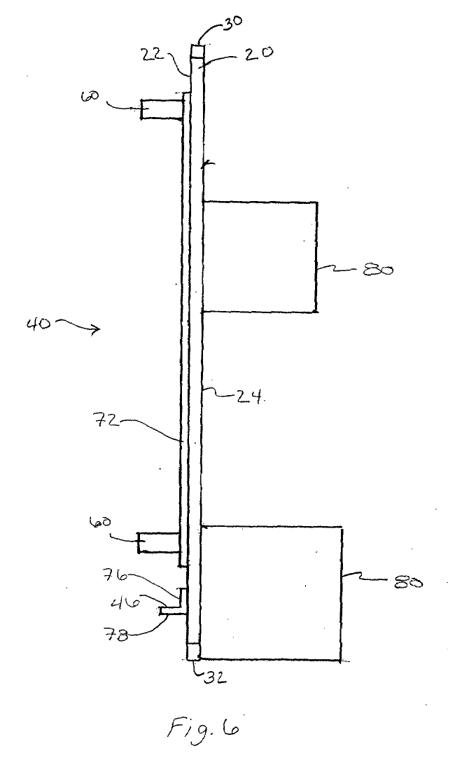

Referring to FIGS. 4-7, the storage device 10 has a planar member 20 having a first side 22 and a second side 24, two side edges 26, 28, a top edge 30, and a bottom edge 32. A mounting assembly 40 for mounting the storage device to a ladder is provided on the first side 22. The mounting assembly includes two leg attachment members 42, 44 that attach to the two vertical legs 14 of the step ladder and a support member 46 that rests on a horizontal cross bar 48 of the ladder. One or more storage bins 80 are provided on the second side 24.

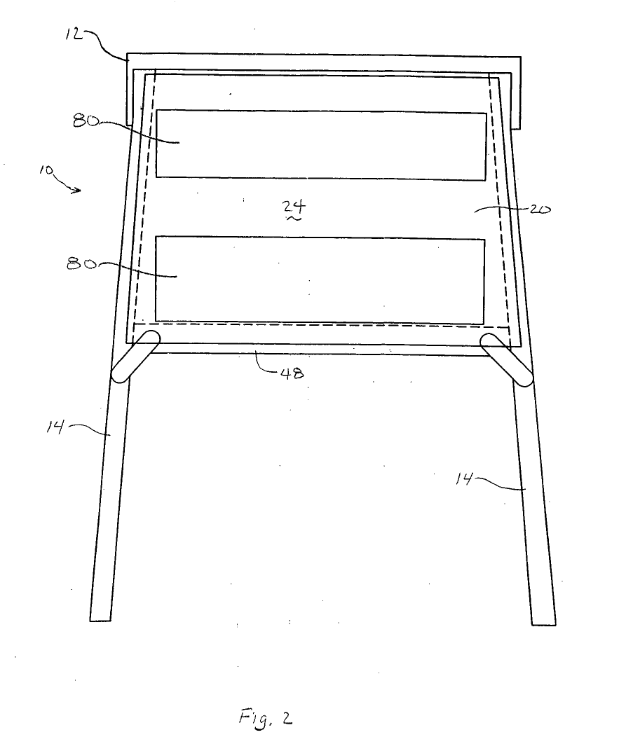

In the embodiment illustrated, the first leg attachment member 42 is a track 50 that runs generally adjacent one side edge 26 of the planar member. The track forms a slot 52 that opens outwardly toward the edge 26 of the planar member 20. A portion 54 of one vertical leg 14 of the ladder fits into the slot. In the embodiment shown, the track is formed by an elongated strip 56 of metal mounted to a spacer strip or cleat 58 mounted to the first side 22 of the planar member 20, although the track can be formed in any suitable manner. If the legs of the step ladder taper toward each other toward the top of the ladder, the track is mounted to the planar member at a corresponding angle, as can be seen in FIGS. 2 and 4.

In the embodiment illustrated, the second leg attachment member 44 is a resilient clip 60 or, more preferably, several resilient clips 60 adjacent the opposite side edge 28 of the planar member 20. The clips are made of a strip 62 of a resilient material, suitably a metal, bent to form a triangular portion 64 having a generally isosceles triangular shape. One end 66 of the strip is bent back inwardly under the triangular portion 64. The other end 68 of the strip is sufficiently long to form an attachment flange 70 that is mounted on a spacer strip or cleat 72 mounted to the first side 22 of the planar member 20. Preferably the mounting assembly employs at least two clips in general vertical alignment. The clips are aligned to match a taper of the ladder's leg. However one or another number of clips can be provided if desired. The clips can be of any suitable size to fasten securely to the ladder's leg. The clips and the track are spaced horizontally to match the horizontal distance between the legs of the ladder. Other clip configurations can be employed.

In the embodiment illustrated, the support member 46 is an elongated angle member 76 extending horizontally adjacent the bottom edge 32 of the planar member 20. A lip 78 of the angle member extends orthogonally outwardly from the planar member so that it can rest on a horizontal cross bar 48 of the ladder. Other support member configurations can be employed. The leg attachment members and the support member can be mounted to the planar member in any suitable manner, for example, with screws or an adhesive.

To mount the storage device to a ladder, one leg 14 of the ladder is aligned on the track 50 of the first leg attachment member by slipping an edge of the leg into the slot 52 of the track. Then the resilient clips 60 are snapped over the other leg 14 of the ladder by pushing the tip 65 of the triangular portion 64 against the ladder's leg. The triangular portion is thereby pushed to the side until the inward end 66 passes the leg, catching the leg between the inward end 66 and the first side 22 of the planar member 20. The planar member is adjusted vertically so that the horizontal lip 78 adjacent the bottom edge 32 of the planar member 20 rests on the cross bar 48 of the ladder. The storage device is preferably mounted near the upper end of the ladder, because it is more accessible to a user standing on the ladder in this location.

The storage bins 80 are provided on the second side 24 of the planar member 20, facing away from the ladder. The storage bins may be of any suitable configuration. In the embodiment shown, two bins are used, although any number of bins may be provided.

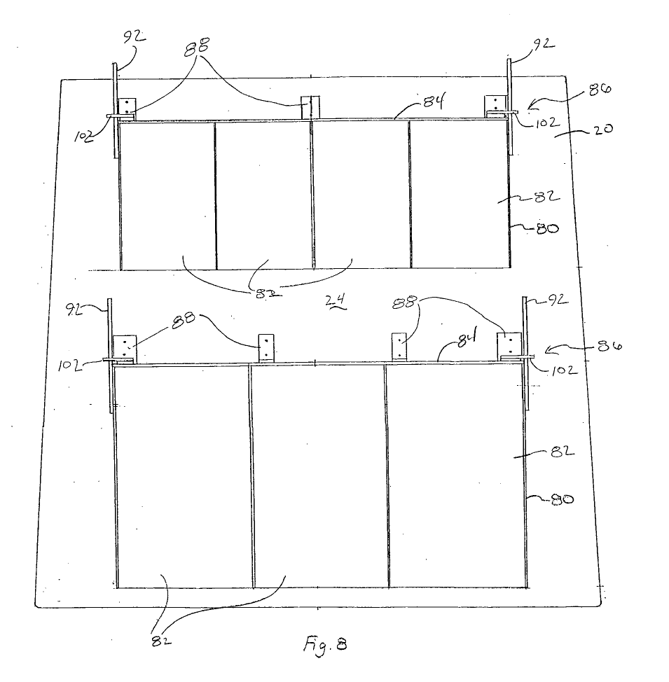

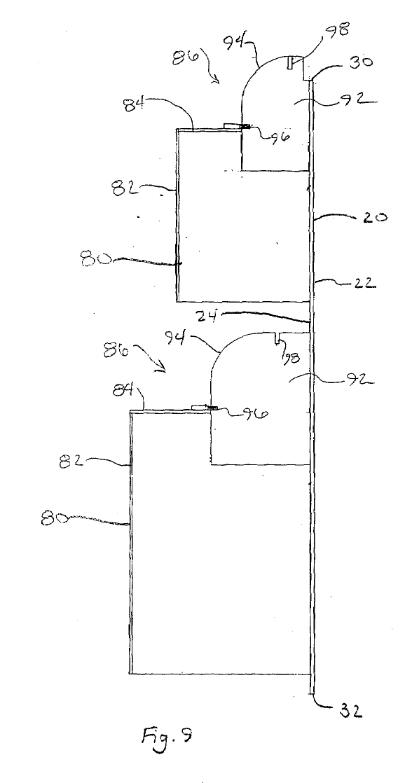

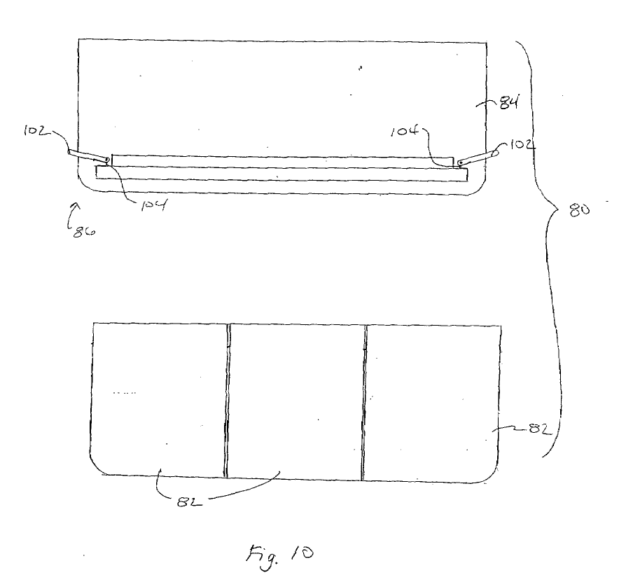

In one embodiment (see FIGS. 8-10), each storage bin 80 comprises one or more boxes 82 having open tops aligned in a row. A hinged cover 84 extends along the length of the boxes 82 and is hingedly mounted to the second side 24 of the planar member 20 with one or more suitable hinges 88. The cover can be latched into a closed position over the open tops and/or an open position with a suitable latching mechanism 86. When closed, the cover provides protection for the contents of the boxes.

The latching mechanism 86 includes two latch plates 92, each having an arced edge 94, that are mounted on opposite sides of the row of boxes 82. The latch plates can be mounted to the planar member 20, to sides of the boxes 82, or to both, in any suitable manner, such as with screws or adhesive. A closing notch 96 is formed into the arced edge of the latch plate at the bottom of the arc, and an opening notch 98 is formed into the arced edge of the latch plate at the top of the arc. The latching mechanism also includes a pair of latching arms 102, each extending outwardly from the cover 84. The latching arms fit into the closing notches 96 when the cover 84 is in the closed position and into the opening notches 92 when the cover 84 is in the open position. The latching arms are preferably biased to remain in a notch with a suitable biasing member 104, such as a leaf spring attached to the cover and the latching arm.

In operation, a user moves the latching arms 102 against the bias of the biasing members 104 to move the latching arms out of the notches 96, 98. When the latching arms are out of the notches, the user can move the cover 84 to the opposite position. Once the cover has moved a sufficient distance along the arced edge 94, the user can release the latching arms. When the cover reaches the opposite position, the latching arms fall into the notch at that position, thereby holding the cover in that position.

The bins 80 can be formed of separate boxes (as shown) or of one elongated box. Partitions, which can be removable or adjustable, can be fitted within the box if desired.

Although particularly described for use with aluminum or fiberglass step ladders, the mounting device can be adapted for use on wooden step ladders, which have generally wider legs. In this case, the leg attachment members may require certain modifications to fit the ladder's legs. The device can also be used on straight ladders. The invention is not to be limited by what has been particularly shown and described, except as indicated by the appended claims.

What is claimed is:

1. A storage device for a ladder comprising:
a planar member comprising a first side and a second side, first and second side edges, a top edge, and a bottom edge;
a mounting assembly on the first side of the planar member, the mounting assembly comprising:
a first leg attachment member comprising a track adjacent the first side edge for receiving a vertical leg of the ladder,
a second leg attachment member comprising a resilient clip adjacent the second side edge for receiving another vertical leg of the ladder, and
a support member adjacent the bottom edge for resting on a horizontal cross bar of the ladder; and
a storage bin on the second side of the planar member.

2. The storage device of claim 1, wherein the track of the first leg attachment member comprises an elongated strip mounted to a cleat mounted to the first side of the planar member, a slot formed between the elongated strip and the first side of the planar member, the slot opening toward the first side edge of the planar member.

3. The storage device of claim 1, wherein the resilient clip comprises a strip of resilient material bent to form a triangular portion, the triangular portion spaced from the first side of the planar member.

4. The storage device of claim 3, wherein the strip of resilient material includes a flange mounted on a cleat mounted to the first side of the planar member.

5. The storage device of claim 3, wherein the resilient material comprises a metal.

6. The storage device of claim 1, wherein the second leg attachment member comprises a further resilient clip adjacent the second side edge of the planar member for receiving the other vertical leg of the ladder.

7. The storage device of claim 1, wherein the first leg attachment member and the second leg attachment member taper together toward the top edge of the planar member, the taper corresponding to a taper of the legs of the ladder.

8. The storage device of claim 1, further comprising an additional storage bin on the second side of the planar member.

9. The storage device of claim 1, wherein the storage bin comprises a box having a open top and a cover hingedly mounted to the second side of the planar member to cover the open top of the box.

10. The storage device of claim 9, further comprising a latching mechanism for latching the cover in an open position.

11. The storage device of claim 9, further comprising a latching mechanism for latching the cover in a closed position.

12. The storage device of claim 9, further comprising a latching mechanism comprising a pair of latching plates mounted on opposed sides of the box, the latching plates including a notch formed therein at an open position and a notch formed therein at a closed position, and a pair of latching arms extending from the cover to fit within either of the notches.

13. The storage device of claim 12, wherein the latching plates have an arced edge, the notches formed in the arced edge.

14. The storage device of claim 1, wherein the ladder is a step ladder.
